(19) United States
(12) Patent Application Publication
(10) Pub. No.: US 2025/0155600 A1
(43) Pub. Date: May 15, 2025

(54) TARGET DETECTION DEVICE AND METHOD

(71) Applicant: Nanjing University of Science and Technology, Nanjing (CN)

(72) Inventors: Leixiang BIAN, Nanjing (CN); Yuntao ZHANG, Nanjing (CN); Yong HE, Nanjing (CN); Zhan XU, Nanjing (CN); Jie HU, Nanjing (CN); Zijun HUANG, Nanjing (CN)

(21) Appl. No.: 19/007,493

(22) Filed: Jan. 1, 2025

Related U.S. Application Data
(63) Continuation of application No. PCT/CN2024/084328, filed on Mar. 28, 2024.

(30) Foreign Application Priority Data
Oct. 20, 2023 (CN) 202311370939.2

(51) Int. Cl. G01V 3/10

(52) U.S. Cl. CPC G01V 3/10

(57) ABSTRACT

The embodiments of the present application provide a target detection device and method, the target detection device comprises: a signal source, a signal transmission module, a signal output module, a bearing portion and a processing module, the signal transmission module is supplied with a step excitation waveform current, the signal transmission module is induced and generates a first magnetic field, a target to be detected is induced and generates a second magnetic field in the first magnetic field, when the signal source is turned off, the signal output module outputs a voltage signal comprising an oscillating voltage signal for detection in a geomagnetic anomaly detection mode and an attenuated voltage signal for detection in an electromagnetic induction time domain detection mode; the processing module is connected to the signal output module, and is used to process the voltage signal and detect the target based on the first signal feature.

### CROSS-REFERENCE

The present application is a continuation of International Application No. PCT/CN2024/084328, filed on Mar. 28, 2024, which claims priority to Chinese Patent Application No. 202311370939.2, filed with the China National Intellectual Property Administration on Oct. 20, 2023, entitled “TARGET DETECTION DEVICE AND METHOD”. The disclosures of the aforementioned applications are hereby incorporated by reference in their entireties.

### TECHNICAL FIELD

The present application relates to the field of communication technology, and in particular to a target detection device and method.

### BACKGROUND

With the development of society, people pay more and more attention to environmental safety and environmental protection. In some areas of the land, metal pollutants and other targets buried underground may cause environmental safety and pollution problems. Therefore, the detection and removal of targets are important guarantees for environmental safety and environmental protection. For example, in areas such as exercises, shooting ranges, and post-war ruins, a large number of unexploded bombs that have not been cleared will cause safety problems and environmental pollution problems. Therefore, it is necessary to detect and remove unexploded bombs.

In some scenarios, electromagnetic induction detection method and geomagnetic anomaly detection method can be used together to detect unexploded bombs. Specifically, the detection devices using different detection methods are integrated into the same carrier platform, or the detection devices using different detection methods are independently operated in the same area, and then the data detected by different detection methods are fused and processed. In this way, the functional separation of the detection devices of unexploded bombs requires the independent operation of different detection devices, and different detection devices will interfere with each other, resulting in low detection accuracy and efficiency of unexploded bombs.

### SUMMARY

The purpose of the embodiments of the present application is to provide a target detection device and method, which can improve the detection accuracy and detection efficiency of unexploded bombs.

In order to solve the above technical problems, the embodiments of the present application are implemented as follows:

In the first aspect, the embodiments of the present application provide a target detection device comprising: a signal source, a signal transmission module, a signal output module, a bearing portion and a processing module, the transmission module and the signal output module are both arranged on the bearing portion; the signal source is connected to the signal transmission module, and the signal output module is connected to the signal transmission module, the signal source is used to supply a step excitation waveform current to the signal transmission module; in one transmission cycle, the signal transmission module is supplied with the step excitation waveform current, the signal transmission module is induced and generates a first magnetic field, a target to be detected is induced and generates a second magnetic field in the first magnetic field, when the signal source is turned off, the signal output module outputs a voltage signal, the voltage signal comprises an oscillating voltage signal when the voltage signal damped vibrates at a natural frequency driven by a step change of the first magnetic field, and an attenuated voltage signal affected by the second magnetic field after vibration ends, the oscillating voltage signal is used for detection in a geomagnetic anomaly detection mode, and the attenuated voltage signal is used for detection in an electromagnetic induction time domain detection mode; the processing module is connected to the signal output module, and is used to process the voltage signal, obtain a first signal feature, and detect the target based on the first signal feature.

In the second aspect, the embodiments of the present application provide a target detection method comprises: acquiring a voltage signal output by the signal output module in a single transmission cycle, the voltage signal comprises an oscillating voltage signal when the voltage signal damped vibrates at a natural frequency driven by a step change of the first magnetic field, and an attenuated voltage signal affected by the second magnetic field after vibration ends, the oscillating voltage signal is used for detection in a geomagnetic anomaly detection mode, and the attenuated voltage signal is used for detection in an electromagnetic induction time domain detection mode; processing the voltage signal to obtain a first signal feature; detecting a target based on the first signal feature.

It can be seen from the technical solution provided by the above embodiments of the present application that when the signal source supplies current to the signal transmission module and cuts off the current, the processing module processes the signal output by the signal output module to obtain the signal features, thereby detecting the target based on the signal features. In this way, the same set of target detection devices can complete the detection of target in multiple modes. Compared with using multiple sets of detection devices with separate functions, its detection efficiency is higher. In addition, the same set of target detection devices can complete the detection of target in multiple modes. There is no need to run multiple sets of detection devices with independent functions, which avoids the problem of mutual interference between detection devices and improves the detection accuracy of target.

### BRIEF DESCRIPTION OF DRAWINGS

In order to more clearly illustrate the technical solutions in the embodiments of the present application or the prior art, the drawings required for describing the embodiments or the prior art are briefly introduced below. Obviously, the drawings described below are only some embodiments recorded in the present application. For those skilled in the art, other drawings can be obtained based on these drawings without creative labor.

FIG. 1A is a structural schematic diagram of the target detection device provided in an embodiment of the present application;

FIG. 1B is a waveform diagram of an input step excitation waveform current and a voltage signal output by a signal output module provided in an embodiment of the present application;

FIG. 2 to FIG. 4 are schematic diagrams of the signal processing process provided in an embodiment of the present application;

FIG. 5 and FIG. 6 are waveform diagrams of the transmission current supplied by the signal source to the transmission coil and the voltage signal output by the signal output module under the background field provided in an embodiment of the present application;

FIG. 7 and FIG. 8 are signal waveform diagrams of the transmission current supplied by the signal source and the target output signal provided in the embodiment of the present application;

FIG. 9 is a response curve diagram of the background field output voltage and the target output voltage after low-pass filtering provided in the embodiment of the present application;

FIG. 10 is a structural schematic diagram of another target detection device provided in the embodiment of the present application;

FIG. 11 is a schematic diagram of the induced magnetic field provided in the embodiment of the present application;

FIG. 12 is a flow diagram of the target detection method provided in the embodiment of the present application.

### DETAILED DESCRIPTION

The embodiments of the present application provide a target detection device and method, which can improve the detection accuracy and detection efficiency of unexploded bombs.

In order to enable those skilled in the art to better understand the technical solutions in the present application, the technical solutions in the embodiments of the present application will be clearly and completely described below in conjunction with the drawings in the embodiments of this application. Obviously, the described embodiments are only part of the embodiments of the present application, not all of them. Based on the embodiments in this application, all other embodiments obtained by those skilled in the art without creative work should fall within the scope of protection of the present application.

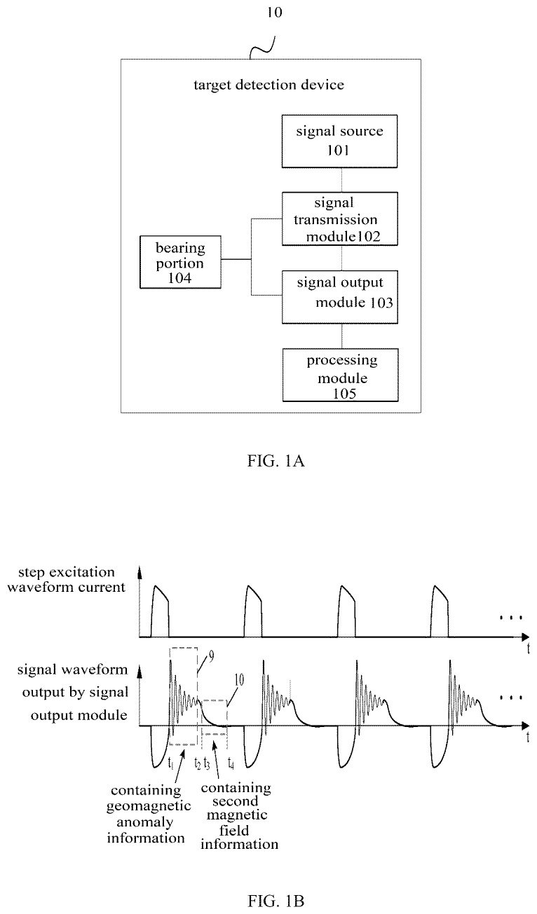

Exemplarily, as shown in FIG. 1A, the embodiment of the present application provides a target detection device 10, the target detection device 10 comprises: a signal source 101, a signal transmission module 102, a signal output module 103, a bearing portion 104 and a processing module 105, the transmission module 102 and the signal output module 103 are both arranged on the bearing portion 104, the signal source 101 is connected to the signal transmission module 102, and the signal output module 103 is connected to the signal transmission module 102, the signal source 101 is used to supply a step excitation waveform current to the signal transmission module 102. In one transmission cycle, the signal transmission module 102 is supplied with the step excitation waveform current, the signal transmission module 102 is induced and generates a first magnetic field, a target to be detected is induced and generates a second magnetic field in the first magnetic field. When the signal source 101 is turned off, the signal output module 103 outputs a voltage signal, the voltage signal comprises an oscillating voltage signal when the voltage signal damped vibrates at a natural frequency driven by a step change of the first magnetic field, and an attenuated voltage signal affected by the second magnetic field after vibration ends, the oscillating voltage signal is used for detection in a geomagnetic anomaly detection mode, and the attenuated voltage signal is used for detection in an electromagnetic induction time domain detection mode; the processing module 105 is connected to the signal output module 103, and is used to process the voltage signal, obtain a first signal feature, and detect the target based on the first signal feature.

Specifically, the signal source 101 is a component that provides a step excitation waveform current to the signal transmission module 102, the transmission frequency of the step excitation waveform current provided by the signal transmission module 102 can be f, and f can be determined according to actual conditions, and the embodiments of the present application are not limited thereto. Further, the step excitation waveform current can be a unipolar rectangular wave current or a bipolar rectangular wave current; the signal transmission module 102 can be a component that is induced and generates a magnetic field signal, which can be a transmission coil, etc.; the signal output module 103 is a component that performs magnetoelectric induction and outputs a voltage signal, for example, it can be a magnetoelectric sensitive component. In a possible implementation, the signal output module 103 comprises a ferromagnetic layer and a piezoelectric layer. When a high-amplitude AC magnetic field is applied to the ferromagnetic layer, the ferromagnetic layer undergoes nonlinear magnetostriction. The magnetoelectric sensitive component composed of the ferromagnetic layer and the piezoelectric layer can complete the magnetic-mechanical-electrical physical field conversion, and then the voltage signal output by the signal output module 103 produces a nonlinear harmonic distortion response, such as frequency doubling effect and high-order harmonics. Under the excitation of the high-amplitude transient magnetic field, the signal output module 103 undergoes damped motion, and the voltage oscillation can be maintained for more than a few hundred microseconds. In addition, the magnetoelectric sensitive component composed of the ferromagnetic layer and the piezoelectric layer can also have a frequency bandwidth of hundreds of kHz, and can also receive AC signals under the nonlinear effect. Under the excitation of the second magnetic field, it outputs a voltage signal through magnetic-mechanical-electrical physical field conversion. Further, the target can be an unexploded bomb, etc.

Further, as shown in FIG. 1B, when a transmission current is supplied once in one transmission cycle, i.e., when a step excitation waveform current is transmitted, the signal output module 103 outputs a corresponding voltage signal, which comprises an oscillating voltage signal when the voltage signal damped vibrates at a natural frequency driven by a step change of the first magnetic field, and an attenuated voltage signal affected by the second magnetic field after vibration ends, such as the oscillating voltage signal (9) in the time period t1 to t2 in FIG. 1B, which contains geomagnetic anomaly information, and the attenuated voltage signal (10) in the time period t3 to t4 in FIG. 1B, which contains the information of the second magnetic field. By analyzing the voltage signal output by the signal output module 103 in one transmission cycle, the detection of the geomagnetic anomaly detection mode and the detection of the electromagnetic induction time domain detection mode can be completed.

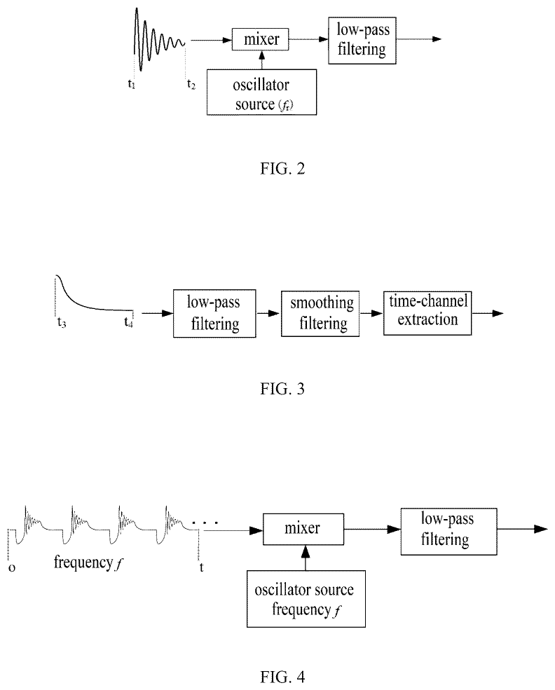

Herein, after the transmission current provided by the signal source 101 is turned off, the first magnetic field undergoes a step change, and the signal output module 103 generates a voltage signal, the voltage signal comprises an oscillating voltage signal generated when the voltage signal damped vibrates at a natural frequency fr driven by a step change of the first magnetic field, and an attenuated voltage signal generated after the oscillation ends. In the geomagnetic anomaly detection mode, the oscillating voltage signal in the voltage signal can be maintained for hundreds of microseconds, and the oscillating voltage signal will be modulated by the geomagnetic anomaly. After receiving the voltage signal, the processing module 105 uses a phase-locked quadrature method to demodulate the oscillating voltage signal in the voltage signal to obtain the voltage amplitude and phase of the resonance point. The first signal feature comprises the voltage amplitude and phase, etc., the geomagnetic anomaly field caused by the target is calculated, the target is identified, and the detection work in the geomagnetic anomaly detection mode is completed. More specifically, the voltage amplitude feature indicates the geomagnetic anomaly information, and the geomagnetic anomaly information refers to the change information of the geomagnetic field caused by the existence of the target. After obtaining the voltage amplitude feature, when the voltage amplitude feature exceeds a first preset range, determining that there is a target in the current detection area, wherein the first preset range is the range of the normal voltage amplitude feature when there is no target object. The first preset range can be determined according to the actual situation, and the embodiments of the present application are not limited thereto. For the voltage waveform and data processing process of the oscillating voltage signal, as shown in FIG. 2, firstly the oscillating voltage signal in the time period t1 to t2 in FIG. 1B is input into the mixer, then the oscillation signal at the natural frequency fr is supplied into the mixer by the oscillation source, then the oscillation signal and the oscillating voltage signal processed by the mixer are subjected to low-pass filtering to obtain the signal feature of the voltage signal. The signal feature comprises the voltage amplitude.

In the electromagnetic induction time domain detection mode, the target generates an attenuated second magnetic field under the eddy current effect, and the attenuation time is tens of seconds. The signal output module 103 starts to attenuate after the oscillation ends, that is, the attenuation curve of the attenuated voltage signal is changed under the influence of the second magnetic field, and the attenuation curve of the voltage contains the information of the transient second magnetic field. After the processing module 105 receives the voltage signal, as shown in FIG. 3, the attenuated voltage signal in the time period t3 to t4 in the voltage signal shown in FIG. 1B is processed in sequence by low-pass filtering, smoothing filtering and time-channel extraction to obtain a response signal feature. When the response signal feature exceeds a second preset range, determining that the target exists, wherein the response signal feature comprises but is not limited to amplitude, phase, real component and imaginary component, etc., and the response signal feature contains the information of the second magnetic field. The second preset range is the range of normal response signal feature when the target does not exist. The second preset range can be determined based on actual conditions, and the embodiments of the present application are not limited thereto.

In a possible implementation, the processing module 105 is further used to acquire a signal waveform output by the signal output module 103, process the signal waveform to obtain a second signal feature, and detect the target based on the second signal feature, wherein the signal waveform is used for detection in the electromagnetic induction frequency domain detection mode, and the signal waveform comprises voltage signals of multiple transmission cycles. As shown in FIG. 1B, in the exemplary four transmission cycles, the signal output module 103 periodically outputs four voltage signals, and the signal waveform comprises four transmission cycle voltage signals.

Furthermore, in a complete cycle, the signal transmission module 102 generates a first magnetic field after the current is passed through it, and the target generates a second magnetic field in the first magnetic field due to the eddy current effect. After the signal source 101 is turned off, the signal output module 103 can output a voltage signal. By analyzing the signal waveform formed by the voltage signal of multiple transmission cycles, the detection of the electromagnetic induction frequency domain detection mode can be realized. Herein, after the signal transmission module 102 is supplied with a current with a transmission frequency f, the target generates a second magnetic field with the same frequency as the current emitted by the signal source 101 under the effect of the first magnetic field. After the signal source 101 is turned off, the signal output module 103 outputs a voltage signal, and the signal waveform contains a signal of the second magnetic field with the same frequency as the step excitation waveform current. After receiving the signal waveform, the processing module 105 demodulates the signal waveform using a phase-locked quadrature demodulation method to obtain the real component and imaginary component of a harmonic wave with a frequency f (smaller than the oscillation frequency). When the real part of the real component exceeds a third preset range, or the imaginary part of the imaginary component exceeds a fourth preset range, determining that the target object exists, and the target is identified to exist in the currently detected area, wherein the third preset range is a normal value range of the real part when the target does not exist, the fourth preset range is a normal value range of the imaginary part when the target does not exist, the third preset range and the fourth preset range can be determined based on actual conditions, the embodiments of the present application are not limited thereto. The processing process of the signal waveform including four transmission cycles shown in FIG. 1B is shown in FIG. 4. After the processing module 105 receives the signal waveform, the signal waveform is firstly supplied into the mixer, and then the oscillation signal with a frequency f is supplied to the mixer from the oscillation source. After the signal waveform and the oscillation signal pass through the mixer, they are subjected to low-pass filtering to obtain the second signal feature of the signal waveform, and the second signal feature comprises the real component and the imaginary component of the harmonic wave.

The principle of the target detection device is explained below. A step excitation waveform current is supplied to the signal transmission module to generate a first magnetic field Bₚ, which causes the signal output module composed of the ferromagnetic layer and the piezoelectric layer to produce nonlinear stress. After the step excitation waveform current is turned off, the first magnetic field undergoes a step change, resulting in a step change in stress. Under the excitation of the step change in stress, the signal output module undergoes second-order damped vibration, and the vibration differential equation is:

$$\frac{{\partial }^{2} u}{\partial {t}^{2}} + \frac{{c}_{1} + {c}_{2}}{Al \overline{ρ}} \frac{\partial u}{\partial t} - K \frac{{\partial }^{2} u}{\partial {z}^{2}} = 0$$

Wherein, c₁ and c₂ are the damping coefficients of the piezoelectric layer and the ferromagnetic layer, respectively. A, l, ρ̅ are the cross-sectional area, length and average density of the signal output module, respectively. K is a constant, which is related to the size and material properties of the piezoelectric layer and the ferromagnetic layer. By substituting the initial velocity 0 of the signal output module and the boundary conditions of both ends being free into the above vibration differential equation, the longitudinal differential equation driven by the first magnetic field Bₚ is obtained:

$$u ( z , t ) = \frac{[ sin ( ω z / \sqrt{K} ) - sin ( ω ( l - z ) / \sqrt{K} ) ]}{ω \sqrt{1 - {ζ}^{2}} sin ( ω l / \sqrt{K} )} [ [ \frac{\sqrt{K} {n}_{2} {s}_{11}^{p} tan ( ω l / 2 \sqrt{K} ) λ ( {T}_{3}^{m} , μ {B}_{e} )}{{n}_{1} {s}_{33}^{m} + {n}_{2} {s}_{11}^{p}} + \frac{2 {n}_{2} [ λ ( {T}_{3}^{m} , μ ( {B}_{p} + {B}_{e} ) ) - λ ( {T}_{3}^{m} , μ {B}_{e} ) ]}{l \overline{ρ} {s}_{33}^{m}} ] {e}^{- ζω t} cos ( ω \sqrt{1 - {ζ}^{2}} t - φ ) - \frac{2 {n}_{2} \sqrt{1 - {ζ}^{2}} [ λ ( {T}_{3}^{m} , μ ( {B}_{p} + {B}_{e} ) ) - λ ( {T}_{3}^{m} , μ {B}_{e} ) ]}{l \overline{ρ} {s}_{33}^{m}} ]$$

Where n₁ and n₂ are the volume proportions of the materials of the piezoelectric layer and the ferromagnetic layer, respectively, z is the displacement of the cross section along the length direction of the piezoelectric layer and the ferromagnetic layer, s₃₃^{m} is the compliance coefficient under a constant magnetic field, s₁₁^{p} is the compliance coefficient under a constant electric field, ζ is the system damping ratio, φ is the phase angle, and ω is the natural frequency fᵣ of the signal output module. μ is the vacuum permeability, λ(T₃^{m}, μBₑ) is the nonlinear magnetostriction coefficient, which is a function of stress T₃^{m} and magnetic induction intensity Bₑ. According to the relationship between electric field and strain in the linear equation of piezoelectric materials, the expression of the output voltage V(t) changing with time can be obtained from the longitudinal differential equation:

$$V ( t ) = - \frac{4 {d}_{31 p} {t}_{p}}{ω l \sqrt{1 - {ζ}^{2}} ( {ε}_{33}^{T} {s}_{11}^{p} - {{d}_{31 p}}^{2} )} [ [ \frac{\sqrt{K} {n}_{2} {s}_{11}^{p} tan ( ω l / 2 \sqrt{K} ) λ ( {T}_{3}^{m} , μ {B}_{e} )}{2 ( {n}_{1} {s}_{33}^{m} + {n}_{2} {s}_{11}^{p} )} + \frac{{n}_{2} [ λ ( {T}_{3}^{m} , μ ( {B}_{p} + {B}_{e} ) ) - λ ( {T}_{3}^{m} , μ {B}_{e} ) ]}{l \overline{ρ} {s}_{33}^{m}} ] {e}^{- ζω t} cos ( ω \sqrt{1 - {ζ}^{2}} t - φ ) - \frac{{n}_{2} \sqrt{1 - {ζ}^{2}} [ λ ( {T}_{3}^{m} , μ ( {B}_{p} + {B}_{e} ) ) - λ ( {T}_{3}^{m} , μ {B}_{e} ) ]}{l \overline{ρ} {s}_{33}^{m}} ]$$

From the above equations, it can be seen that the voltage oscillates at the natural frequency of the signal output module and attenuates exponentially. After the oscillation ends, the charge on the surface of the piezoelectric layer are quickly neutralized and the voltage is gradually attenuated. Due to the nonlinear magnetoelectric effect, when the ambient magnetic field changes, the magnetic field signal mixes with the oscillating voltage signal, the output voltage is modulated, and the amplitude is changed.

Herein, in the geomagnetic anomaly detection mode, the target is magnetized under the action of the geomagnetic field, a magnetic anomaly field is generated. Due to the nonlinear magnetoelectric effect of the signal output module, the oscillating voltage signal is modulated by the magnetic anomaly field, and the amplitude changes. By demodulating the voltage component at the resonant frequency point, the geomagnetic anomaly information can be obtained to determine whether there is an unexploded bomb in the current detection area. In the electromagnetic induction time domain detection mode, the target generates a decaying second magnetic field due to the eddy current effect under the action of the first magnetic field. The second magnetic field will hinder the attenuation of the voltage after the vibration of the signal output module ends. By extracting the information of the second magnetic field after processing the late voltage attenuated signal, it is determined whether there is an unexploded bomb in the current detection area. In the electromagnetic induction frequency domain detection mode, the frequency bandwidth of the signal output module can reach several hundred kHz. Under the excitation of the first magnetic field with a frequency f, an output voltage with the same frequency will be generated. By demodulating the voltage harmonic wave with frequency f, the real and imaginary components containing the secondary field signal are obtained to determine whether there is an unexploded bomb in the current detection area.

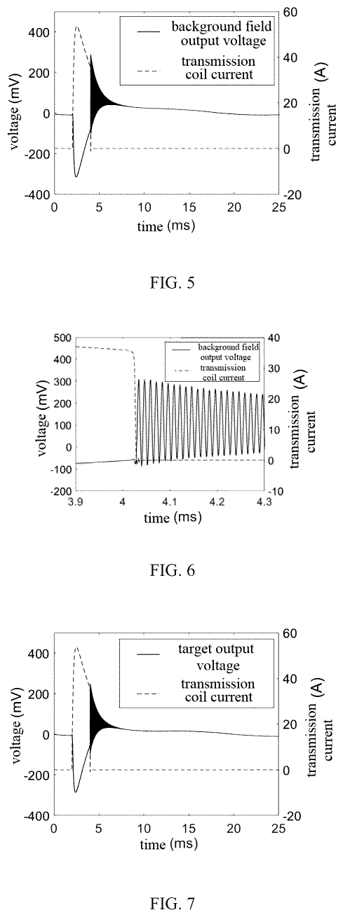

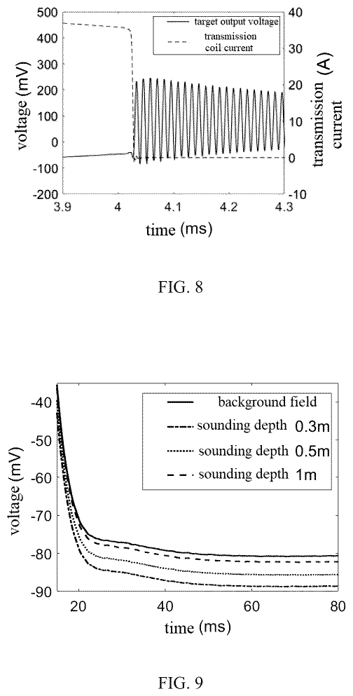

The following is an example of the signal waveform diagram in the geomagnetic anomaly detection mode and the electromagnetic induction time domain detection mode in conjunction with the accompanying drawings. FIG. 5 is a waveform diagram of the transmission current supplied by the signal source to the transmission coil and the voltage signal output by the signal output module under the background field, and FIG. 6 is a partial enlarged diagram of the signal in FIG. 5, wherein the background field refers to the magnetic field without the presence of the target; FIG. 7 is a signal waveform diagram of the transmission current supplied by the signal source and the target output signal, and FIG. 8 is a partial enlarged diagram of the signal in FIG. 7, wherein the target output signal refers to the voltage signal output by the signal output module when the target exists. It can be seen from FIG. 5 and FIG. 7 that after the current is turned off, the signal output module undergoes damped vibration and generates a voltage signal. The output voltage signal can be used for feature extraction processing in the electromagnetic induction time domain detection mode and the geomagnetic anomaly detection mode, respectively. Comparing FIG. 6 and FIG. 8, the amplitude of the output voltage signal when the target exists is less than the amplitude of the output voltage signal of the background field. The data feature value obtained by further processing the output voltage signal can be used to identify the unexploded bomb. FIG. 9 shows the response curve diagram of the voltage signal output by the background field and the target output voltage after low-pass filtering. The target responds differently compared to the background field does at different sounding depths. The response feature value is obtained by time-channel extraction processing and compared with the set threshold to identify unexploded bombs.

It can be seen from the technical solution provided by the above embodiment of the present application that in one transmission cycle, during which the signal source supplies the step excitation waveform current to the signal transmission module and turns off the step excitation waveform current, the voltage signal output by the signal output module comprises an oscillating voltage signal when the voltage signal damped vibrates at a natural frequency driven by a step change of the first magnetic field, and an attenuated voltage signal affected by the second magnetic field after vibration ends. The oscillating voltage signal is used for detection in the geomagnetic anomaly detection mode, and the attenuated voltage signal is used for detection in the electromagnetic induction time domain detection mode. After the processing module processes the voltage signal output by the signal output module, a first signal feature is obtained, thereby detecting the target based on the first signal feature. In this way, the same set of target detection devices can complete the detection of target in multiple modes with a single supply of step excitation waveform current. Compared with using multiple sets of detection devices with separate functions, it effectively saves detection time and achieves a higher detection efficiency. In addition, the same set of target detection devices can complete the detection of target in multiple modes. There is no need to run multiple sets of detection devices with independent functions, which avoids the problem of mutual interference between detection devices and improves the detection accuracy of target.

In a possible implementation, in order to improve the detection capability for the target, the target detection device further comprises: a signal amplification module, which is connected to the signal output module and is used to amplify the voltage signal, wherein the signal amplification module can be a signal amplifier, etc.

In a possible implementation, in order to improve the detection capability and recognition capability for the target and reduce the false alarm rate, the signal output module 103 can be arranged in an array, and the orthogonal three components of the geomagnetic anomaly and the second magnetic field can be measured simultaneously, thereby improving the detection capability and recognition capability for the target.

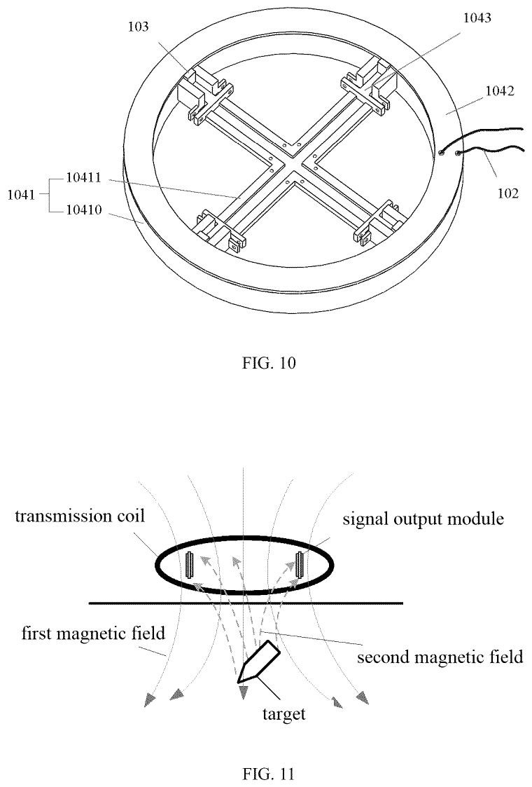

Another embodiment provided by the present application is described below in conjunction with FIG. 10. As shown in FIG. 10, the target detection device comprises: a signal source (not shown), a signal output module 103, a signal transmission module 102, a bearing portion 104 and a processing module 105 (not shown), the bearing portion 104 comprises: a frame 1041, a cover plate 1042 and a clamping slider 1043; the frame 1041 comprises an annular part 10410 and a guide rail part 10411, the annular part 10410 is sleeved on the guide rail part 10411, and the guide rail part 10411 is connected to the annular part 10410; the annular part 10410 is provided with a circular groove for fixing the signal transmission module 102, the cover plate 1042 covers the circular groove, the cover plate 1042 is provided with a through hole, and the signal transmission module 102 is connected to the signal source 101 through the through hole; the clamping slider 1043 is movably connected to the guide rail part 10411, and the signal output module 103 is fixed to the clamping slider 1043.

Herein, when the signal transmitting module 102 is a transmission coil, the transmission coil is wound in the circular groove, and the cover plate 1042 covers the upper surface of the circular groove, so that the transmission coil can be placed in a closed space to avoid damage. The guide rail part 10411 is a cross-shaped groove slide rail structure, the clamping end of the clamping slider 1043 is an “M”-shaped structure, and the other end is a raised rectangular slider. The clamping slider 1043 can be embedded in the cross-shaped groove slide rail of the guide rail part 10411, and can slide freely on the slide rail, and is connected to the guide rail part 10411 by the cooperation of bolts and nuts. The signal output module 103 is placed in the cross-shaped groove of the guide rail part 10411, and the signal output module 103 is fixed to the clamping slider 1043, and the signal output module 103 can slide in the cross-shaped groove of the guide rail part.

As shown in FIG. 11, after the current is passed through the transmission coil, a first magnetic field is generated, and the target is induced and generates a second magnetic field in the first magnetic field due to the eddy current effect.

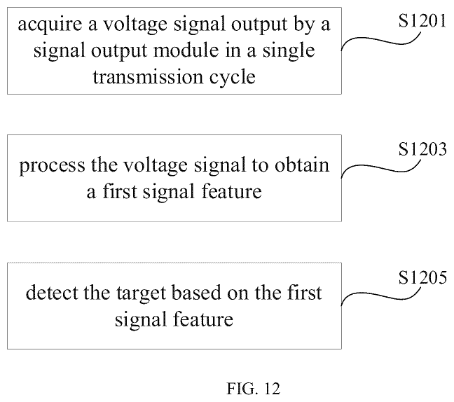

The present application also discloses a target detection method. As shown in FIG. 12, the target detection method comprises the following steps:

Step S1201, a voltage signal output by the signal output module in a single transmission cycle is obtained.

The voltage signal comprises an oscillating voltage signal when the voltage signal damped vibrates at a natural frequency driven by a step change of the first magnetic field, and an attenuated voltage signal affected by the second magnetic field after vibration ends, the oscillating voltage signal is used for detection in a geomagnetic anomaly detection mode, and the attenuated voltage signal is used for detection in an electromagnetic induction time domain detection mode.

Step S1203, the voltage signal is processed to obtain a first signal feature.

In a possible implementation, processing the voltage signal to obtain the first signal feature comprises: demodulating the oscillating voltage signal using a phase-locked quadrature method to obtain a voltage amplitude feature of a resonance point, the voltage amplitude feature indicates geomagnetic anomaly information; and subjecting the attenuated voltage signal to low-pass filtering, smoothing filtering and time-channel extraction to obtain a response signal feature, the first signal feature comprises the voltage amplitude feature and the response signal feature, and the response signal feature indicates an attenuated second magnetic field information.

In a possible implementation, processing the signal waveform comprises: demodulating the signal waveform using a phase-locked quadrature demodulation method to obtain the real component and the imaginary component of the harmonic wave, and the second signal feature comprises the real component and the imaginary component.

Step S1205, a target is detected based on the first signal feature.

In a possible implementation, detecting a target based on the first signal feature comprises: when the voltage amplitude feature exceeds a first preset range, determining that the target exists; and when the response signal feature exceeds a second preset range, determining that the target exists.

In a possible implementation, detecting a target based on the second signal feature comprises: when the real part of the real component exceeds a third preset range, or the imaginary part of the imaginary component exceeds a fourth preset range, determining that the target exists.

With the technical solution disclosed in the embodiment of the present application, the target detection device can complete the detection of the target in multiple detection modes with a single supply of step excitation waveform current. Compared with using multiple sets of detection devices with separate functions, the detection time is effectively saved, and the detection efficiency is higher. In addition, the target detection device of the present disclosure can complete the detection of the target in multiple detection modes, and there is no need to run multiple sets of detection devices with independent functions, which avoids the problem of mutual interference between the detection devices and improves the detection accuracy of target.

It should be noted that the target detection method disclosed in the embodiment of the present application is a method based on the target detection device described above. For the same or similar parts, reference can be made to each other, and it will not be repeated here with respect to the embodiments of the present application.

Those skilled in the art should understand that the embodiments of the present application can be provided as methods, devices, or computer program products. Therefore, the present application can take the form of a complete hardware embodiment, a complete software embodiment, or an embodiment combining software and hardware. Moreover, the present application can take the form of a computer program product implemented on one or more computer-usable storage media (including but not limited to disk storage, CD-ROM, optical storage, etc.) containing computer-usable program codes.

The present application is described with reference to the flowcharts and/or block diagrams of the methods, devices (systems), and computer program products according to the embodiments of the present application. It should be understood that each process and/or block in the flowchart and/or block diagram, as well as the combination of processes and/or blocks in the flowchart and/or block diagram, can be implemented by the computer program instructions. These computer program instructions may be provided to a processor of a general-purpose computer, a special-purpose computer, an embedded processor, or other programmable data processing device to produce a machine, so that the instructions executed by the processor of the computer or other programmable data processing device produce a device for implementing the functions specified in one or more processes of the flowchart and/or one or more blocks of the block diagram.

These computer program instructions may also be stored in a computer-readable memory that can direct a computer or other programmable data processing device to work in a specific manner, so that the instructions stored in the computer-readable memory produce a product including an instruction device that implements the functions specified in one or more processes of the flowchart and/or one or more blocks of the block diagram.

These computer program instructions may also be loaded onto a computer or other programmable data processing device, so that a series of operation steps are performed on the computer or other programmable device to produce a computer-implemented process, so that the instructions executed on the computer or other programmable device provide steps for implementing the functions specified in one or more processes of the flowchart and/or one or more blocks of the block diagram.

In a typical configuration, the electronic device includes one or more processors (CPU), input/output interface, network interface and memory.

Memory may include non-permanent storage in computer-readable media, random access memory (RAM) and/or non-volatile memory such as read-only memory (ROM) or flash RAM. Memory is an example of computer-readable media.

Computer-readable media include permanent and non-permanent, removable and non-removable media that can be implemented by any method or technology to store information. Information can be computer-readable instructions, data structures, program modules or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital versatile disk (DVD) or other optical storage, magnetic cassettes, magnetic tape magnetic disk storage or other magnetic storage devices or any other non-transmission media that can be used to store information that can be accessed by a computing device. As defined herein, computer-readable media do not include transitory media such as modulated data signals and carrier waves.

It should also be noted that the terms “comprise”, “contain” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “comprise one of . . . ” do not exclude the presence of other identical elements in the process, method, article or device including the elements.

Those skilled in the art should understand that the embodiments of the present application can be provided as methods, devices or computer program products. Therefore, the present application can take the form of a complete hardware embodiment, a complete software embodiment or an embodiment combining software and hardware. Moreover, the present application can take the form of a computer program product implemented on one or more computer-usable storage media (including but not limited to disk storage, CD-ROM, optical storage, etc.) containing computer-usable program codes.

The above are only embodiments of the present application and are not intended to limit the present application. For those skilled in the art, the present application can have various changes and variations. Any modifications, equivalent substitutions, improvements, etc. made within the principles of the present application should be included in the scope of the claims of the present application.

1. A target detection device, comprising: a signal source, a signal transmission module, a signal output module, a bearing portion and a processing module, wherein the transmission module and the signal output module are both arranged on the bearing portion;
the signal source is connected to the signal transmission module, and the signal output module is connected to the signal transmission module, the signal source is used to supply a step excitation waveform current to the signal transmission module;
in one transmission cycle, the signal transmission module is supplied with the step excitation waveform current, the signal transmission module is induced and generates a first magnetic field, a target to be detected is induced and generates a second magnetic field in the first magnetic field, when the signal source is turned off, the signal output module outputs a voltage signal, the voltage signal comprises an oscillating voltage signal when the voltage signal damped vibrates at a natural frequency driven by a step change of the first magnetic field, and an attenuated voltage signal affected by the second magnetic field after vibration ends, the oscillating voltage signal is used for detection in a geomagnetic anomaly detection mode, and the attenuated voltage signal is used for detection in an electromagnetic induction time domain detection mode; and
the processing module is connected to the signal output module, and is used to process the voltage signal, obtain a first signal feature, and detect the target based on the first signal feature.

2. The target detection device of claim 1, wherein the processing module is further used to acquire a signal waveform output by the signal output module, process the signal waveform to obtain a second signal feature, and detect the target based on the second signal feature, wherein the signal waveform is used for detection in an electromagnetic induction frequency domain detection mode, and the signal waveform comprises voltage signals of multiple transmission cycles.

3. The target detection device of claim 1, wherein the target detection device further comprises: a signal amplification module, which is connected to the signal output module and is used to amplify the voltage signal.

4. The target detection device of claim 1, wherein the signal output module comprises a ferromagnetic layer and a piezoelectric layer.

5. The target detection device of claim 1, wherein the signal transmission module comprises a transmission coil.

6. The target detection device of claim 1, wherein the bearing portion comprises: a frame, a cover plate and a clamping slider;
wherein the frame comprises an annular part and a guide rail part, the annular part is sleeved on the guide rail part, and the guide rail part is connected to the annular part;
the annular part is provided with a circular groove for fixing the signal transmission module, the cover plate covers the circular groove, the cover plate is provided with a through hole, and the signal transmission module is connected to the signal source through the through hole; and
the clamping slider is movably connected to the guide rail part, and the signal output module is fixed to the clamping slider.

7. A target detection method, based on the target detection device according to claim 1, the target detection method comprises:
acquiring a voltage signal output by a signal output module in a single transmission cycle, the voltage signal comprises an oscillating voltage signal when the voltage signal damped vibrates at a natural frequency driven by a step change of the first magnetic field, and an attenuated voltage signal affected by the second magnetic field after vibration ends, the oscillating voltage signal is used for detection in a geomagnetic anomaly detection mode, and the attenuated voltage signal is used for detection in an electromagnetic induction time domain detection mode;
processing the voltage signal to obtain a first signal feature;
detecting a target based on the first signal feature.

8. The target detection method of claim 7, wherein the method further comprises:
acquiring a signal waveform, and processing the signal waveform to obtain a second signal feature, the signal waveform comprises voltage signals of multiple transmission cycles; and
detecting the target based on the second signal feature, wherein the signal waveform is used for detection in an electromagnetic induction frequency domain detection mode.

9. The target detection method of claim 7, wherein processing the voltage signal to obtain a first signal feature comprises:
demodulating the oscillating voltage signal using a phase-locked quadrature method to obtain a voltage amplitude feature of a resonance point, the voltage amplitude feature indicates geomagnetic anomaly information; and
subjecting the attenuated voltage signal to low-pass filtering, smoothing filtering and time-channel extraction processing to obtain a response signal feature, the first signal feature comprises the voltage amplitude feature and the response signal feature, and the response signal feature indicates an attenuated second magnetic field information;
wherein detecting a target based on the first signal feature comprises:
in response to that the voltage amplitude feature exceeds a first preset range, determining that the target exists; and
in response to that the response signal feature exceeds a second preset range, determining that the target exists.

10. The target detection method of claim 8, wherein processing the signal waveform comprises:
demodulating the signal waveform using a phase-locked quadrature demodulation method to obtain a real component and an imaginary component of a harmonic wave, and the second signal feature comprises the real component and the imaginary component;
wherein detecting the target based on the second signal feature comprises:
in response to that the real part of the real component exceeds a third preset range, or the imaginary part of the imaginary component exceeds a fourth preset range, determining that the target exists.

11. The target detection device of claim 2, wherein the bearing portion comprises: a frame, a cover plate and a clamping slider;
wherein the frame comprises an annular part and a guide rail part, the annular part is sleeved on the guide rail part, and the guide rail part is connected to the annular part;
the annular part is provided with a circular groove for fixing the signal transmission module, the cover plate covers the circular groove, the cover plate is provided with a through hole, and the signal transmission module is connected to the signal source through the through hole; and
the clamping slider is movably connected to the guide rail part, and the signal output module is fixed to the clamping slider.

12. The target detection device of claim 3, wherein the bearing portion comprises: a frame, a cover plate and a clamping slider;
wherein the frame comprises an annular part and a guide rail part, the annular part is sleeved on the guide rail part, and the guide rail part is connected to the annular part;
the annular part is provided with a circular groove for fixing the signal transmission module, the cover plate covers the circular groove, the cover plate is provided with a through hole, and the signal transmission module is connected to the signal source through the through hole; and
the clamping slider is movably connected to the guide rail part, and the signal output module is fixed to the clamping slider.

13. The target detection device of claim 4, wherein the bearing portion comprises: a frame, a cover plate and a clamping slider;
wherein the frame comprises an annular part and a guide rail part, the annular part is sleeved on the guide rail part, and the guide rail part is connected to the annular part;
the annular part is provided with a circular groove for fixing the signal transmission module, the cover plate covers the circular groove, the cover plate is provided with a through hole, and the signal transmission module is connected to the signal source through the through hole; and
the clamping slider is movably connected to the guide rail part, and the signal output module is fixed to the clamping slider.

14. The target detection device of claim 5, wherein the bearing portion comprises: a frame, a cover plate and a clamping slider;
wherein the frame comprises an annular part and a guide rail part, the annular part is sleeved on the guide rail part, and the guide rail part is connected to the annular part;
the annular part is provided with a circular groove for fixing the signal transmission module, the cover plate covers the circular groove, the cover plate is provided with a through hole, and the signal transmission module is connected to the signal source through the through hole; and
the clamping slider is movably connected to the guide rail part, and the signal output module is fixed to the clamping slider.
